(19) United States
(12) Patent Application Publication
(10) Pub. No.: US 2009/0159400 A1
(43) Pub. Date: Jun. 25, 2009

(54) APPARATUS FOR PUSHING ITEMS RELATIVE TO A SURFACE

(75) Inventors: Normand Davidzon, Brighton East (AU); Greg Bellman, Research (AU)

Correspondence Address: ROTHWELL, FIGG, ERNST & MANBECK, P.C., 1425 K STREET, N.W., SUITE 800, WASHINGTON, DC, 20005, US

(73) Assignee: VISY R & D PTY LTD, Melbourne (AU)

(21) Appl. No.: 11/962,684

(22) Filed: Dec. 21, 2007

(51) Int. Cl. B65G 47/82

(52) U.S. Cl. 198/370.07

(57) ABSTRACT

An apparatus for pushing items relative to a conveyor includes a pushing member for abutting against the items so as to push the items in a direction generally transverse to the conveyor, drive means for driving movement of the pushing member, and a linkage coupling the drive means to the pushing member. The linkage is arranged such that in response to operation of the drive means the pushing member moves from a rest position to an extended position in a first stroke substantially horizontally in the direction transverse to the conveyor so as to push the items relative to the conveyor, and with further operation of the drive means the pushing member returns to the rest position in a second stroke with an arcuate motion for passing over the top of items on the conveyor.

### FIELD OF THE INVENTION

This invention relates to an apparatus for pushing items relative to a surface, and more particularly, but not exclusively, to an articulated pushing apparatus for pushing items from a conveyor.

### BACKGROUND OF THE INVENTION

It is known to provide a push off diverter for pushing objects off a conveyer. An example push off diverter is pneumatically operated to move forward and backward across a conveyor for pushing objects from the conveyor or for transferring objects from one conveyor to another conveyor.

However, previously proposed push off diverters of the above type may slow progress of objects along the conveyor by blocking passage of objects on the conveyor when the push off diverter is not fully retracted. Furthermore, abrupt operation of the push off diverter may cause damage to objects being pushed from the conveyor, and may lead to improper placement of the objects once transferred from the conveyor.

Examples of the present invention seek to provide an improved apparatus for pushing items from a conveyor.

### SUMMARY OF THE INVENTION

In accordance with one aspect of the present invention, there is provided an apparatus for pushing items relative to a surface, the apparatus including a pushing member for engaging the items, and drive means for moving the pushing member such that in response to operation of the drive means the pushing member moves from a rest position to an extended position in a first stroke substantially horizontally in a direction across the surface so as to push the items relative to the surface, and with further operation of the drive means the pushing member returns to the rest position in a second stroke with an arcuate motion which clears items on the surface.

Preferably, the surface is a conveyor, and the first stroke is in a direction transverse to the conveyor. More preferably the apparatus includes a linkage coupling the drive means to the pushing member, and the linkage is arranged to provide movement of the pushing member in said first and second strokes in response to operation of the drive means.

Preferably, the drive means is a rotational member. More preferably, the linkage is arranged such that with constant rotational velocity of the rotational member the pushing member accelerates then decelerates along the first stroke, and with continuous rotation of the rotational member the pushing member repeatedly cycles through the first and second strokes. Even more preferably, the rotational member is driven by a motor and rotates about an axis which is fixed in relation to a support of the conveyor.

In a preferred form, the rotational member includes a driving arm, and the linkage includes:
a link pivotally coupled between the driving arm and the pushing member;
an elongated arm pivotally coupled between the link and a pivot fixed in position relative to the support of the conveyor, the elongated arm being arranged to oscillate about the pivot in response to continuous rotation of the rotational member; and
a tie member pivotally coupled between the elongated arm and the pushing member;
   wherein dimensions of the link, the elongated arm and the tie member, and the locations of the pivots, are selected to provide said motion of the pushing member along the first and second strokes.

Preferably, the arcuate motion is generally parabolic.

Preferably, the arcuate motion enables the pushing member to clear incoming items on the conveyor when returning to the rest position through the second stroke.

In accordance with another aspect of the present invention, there is provided an apparatus for pushing items relative to a surface, the apparatus including a pushing member for engaging the items, and drive means for moving the pushing member such that in response to operation of the drive means the pushing member moves from a rest position to an extended position in a first stroke substantially horizontally in a direction across the surface so as to push the items relative to the surface, the pushing member accelerating then decelerating along the first stroke, and wherein with further operation of the drive means the pushing member returns to the rest position in a second stroke.

Preferably, the surface is a conveyor, and the first stroke is in a direction transverse to the conveyor. More preferably, the apparatus includes a linkage coupling the drive means to the pushing member, and the linkage is arranged to provide movement of the pushing member in said first and second strokes in response to operation of the drive means.

Preferably, the drive means is a rotational member. More preferably, the linkage is arranged such that with constant rotational velocity of the rotational member the pushing member accelerates during a start portion of the first stroke and then decelerates during an end portion of the first stroke. Even more preferably, the linkage is arranged such that with continuous rotation of the rotational member the pushing member repeatedly cycles through the first and second strokes. More preferably still, the linkage is arranged such that the rotational member is beyond a dead centre position when the pushing member is in the rest position. In a preferred example, the rotational member is driven by a motor and rotates about an axis which is fixed in relation to a support of the conveyor.

In one form, the rotational member includes a driving arm, and the linkage includes:
a link pivotally coupled between the driving arm and the pushing member;
an elongated arm pivotally coupled between the link and a pivot fixed in position relative to the support of the conveyor, the elongated arm being arranged to oscillate about the pivot in response to continuous rotation of the rotational member; and
a tie member pivotally coupled between the elongated arm and the pushing member;
   wherein dimensions of the link, the elongated arm and the tie member, and the locations of the pivots, are selected to provide the acceleration then deceleration of the pushing member along the first stroke.

### BRIEF DESCRIPTION OF THE DRAWINGS

The invention is described by way of non-limiting example only, with reference to the accompanying drawings in which:

FIG. 1 is a perspective view of an apparatus for pushing items relative to a conveyor;

FIG. 2A is a top view of the apparatus, shown in a rest position;

FIG. 2B is a side view of the apparatus, also shown in the rest position;

FIG. 3A is a top view of the apparatus, shown in an extended position;

FIG. 3B is a side view of the apparatus, also shown in the extended position;

FIG. 4 is a side view of a portion of the apparatus, showing movement through a first stroke;

FIG. 5 is a side view of the same portion of the apparatus shown in FIG. 4, depicting movement through a second stroke;

FIG. 6 is a partly exploded perspective view of the apparatus;

FIG. 7 is a simplified diagram representing basic linkages of the apparatus shown in FIGS. 1 to 6.

### DETAILED DESCRIPTION

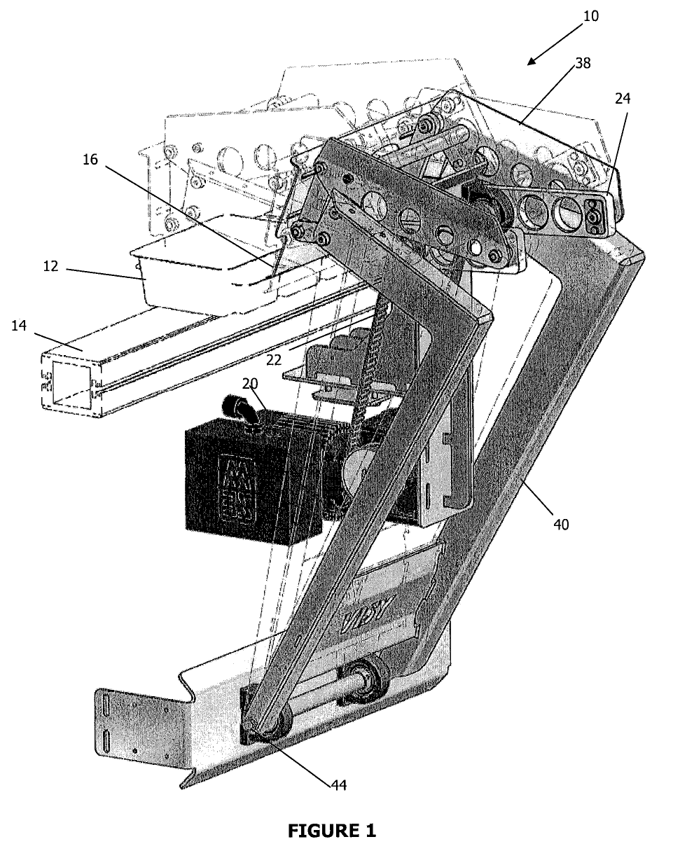

With reference to FIG. 1 there is shown an apparatus 10 for pushing items 12 relative to a conveyor 14. The apparatus 10 is shown in solid lines in a rest position, which the apparatus 10 adopts prior to pushing the items 12 from the conveyor 14, and is shown in broken lines in an extended position, which is adopted by the apparatus 10 after pushing the items 12 from the conveyor 14.

The apparatus 10 includes a pushing member 16 which is used for abutting against the items 12 so as to push the items 12 in a direction generally transverse to the conveyor 14. Although the direction generally transverse to the conveyor 14 as depicted in the drawings is substantially perpendicular to the direction of the conveyor 14, it will be understood by those skilled in the art that in other examples the direction generally transverse to the conveyor 14 may not necessarily be perpendicular to the direction of the conveyor 14. The apparatus 10 also includes drive means in the form of a rotational member 18, which itself is driven by a motor 20 via a belt 22. The rotational member 18 is coupled to the pushing member 16 via a linkage 26 through which the pushing member 16 is driven by the rotational member 18.

The linkage 26 is arranged such that in response to operation of the motor 20, the pushing member 16 moves from the rest position to the extended position in a first stroke substantially horizontally in the direction transverse to the conveyor 14, so as to push the items 12 relative to the conveyor 14. In response to further operation of the motor 20, the pushing member 16 is returned to the rest position through a second stroke with an arcuate motion for passing over the top of items on the conveyor 14.

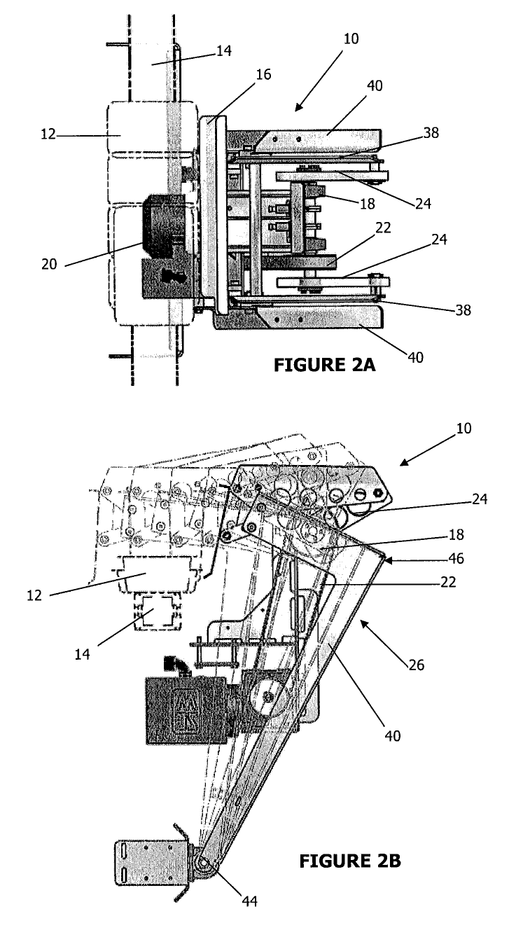

With reference to FIG. 2A, the apparatus 10 is shown in the rest position in which the pushing member 16 is retained clear of the conveyor 14. The conveyor 14 and the items 12 are shown in broken lines so as to show the motor 20 beneath the conveyor 14.

FIG. 2B shows the apparatus 10 in the same rest position depicted in FIG. 2A, and also depicts in broken lines subsequent positions of the apparatus 10 progressively at intervals during the first stroke. The linkage 26 is arranged such that with constant rotational velocity of the rotational member 18 the pushing member accelerates during an initial part of the first stroke, then decelerates during a final part of the first stroke. Also, with continuous rotation of the rotational member 18, the pushing member 16 repeatedly cycles through the first and second strokes. Where items 12 are constantly being fed along the conveyor 14, it may be desirable to run the motor 20 continuously so as to continuously cycle the apparatus 10 through the first and second strokes so as to push the items 12 from the conveyor 14 as quickly as possible. Alternatively, in the case where there are intervals between the items 12 arriving in front of the pushing member 16, it may be desirable to pause the motor 20 to hold the apparatus 10 in the rest position to await a full complement of items 12 in front of the pushing member 16 prior to operating the apparatus 10 through its cycle of the first and second strokes. As will be appreciated from the view shown in FIG. 2B, the rotational member 18 rotates about an axis 28 which is fixed in relation to a support of the conveyor 14. More particularly, in the case where the support of the conveyor 14 is in the form of a stationary frame structure as is commonly the case, the axis 28 about which the rotational member 18 rotates is also stationary.

As shown in FIG. 2B, the linkage 26 is arranged such that the rotational member 18 is rotated beyond a horizontal dead centre position when the pushing member 16 is in the rest position. Advantageously, this results in beginning the first stroke when there is a non-zero horizontal component to the instantaneous direction of movement of a driving arm 36 of the rotational member 18, as well as when the pushing member 16 has been fully lowered with a pushing surface of the pushing member 16 in a substantially vertical orientation. In that regard, the apparatus 10 in the example shown is configured such that at the beginning of the second stroke lowering of the driving arm 36 from an opposed horizontal dead centre position results in upward movement of the pushing member 16 away from the level of the surface of the conveyor. Similarly, at the end of the second stroke after rotation of approximately 180 degrees, raising of the driving arm 36 to the horizontal dead centre position results in lowering of the pushing member 16 to the surface of the conveyor 14.

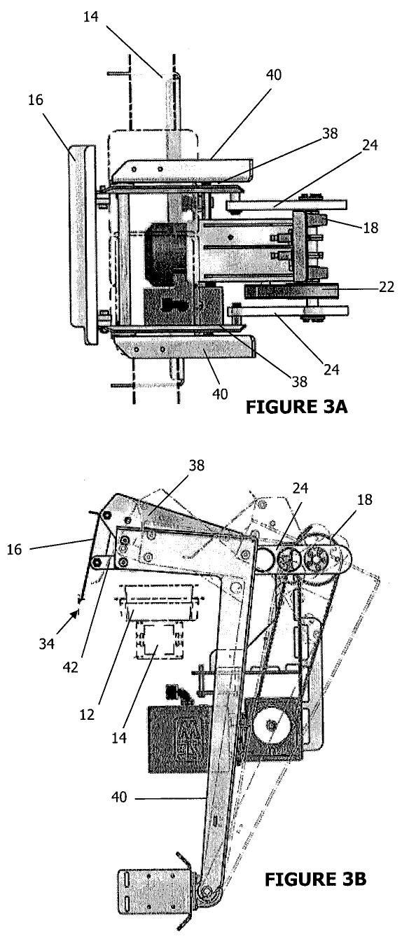

With reference to FIG. 3A, the top view of the apparatus 10 shows the arrangement of the linkage 26 when the pushing member 16 is in the extended position between the first and second strokes, after pushing the items 12 from the conveyor 14. FIG. 3B shows a side view of the apparatus 10 in the extended position in solid lines, and also shows (in broken lines) the configuration of the apparatus 10 at subsequent stages during the second stroke wherein the pushing member 16 is returned to the rest position.

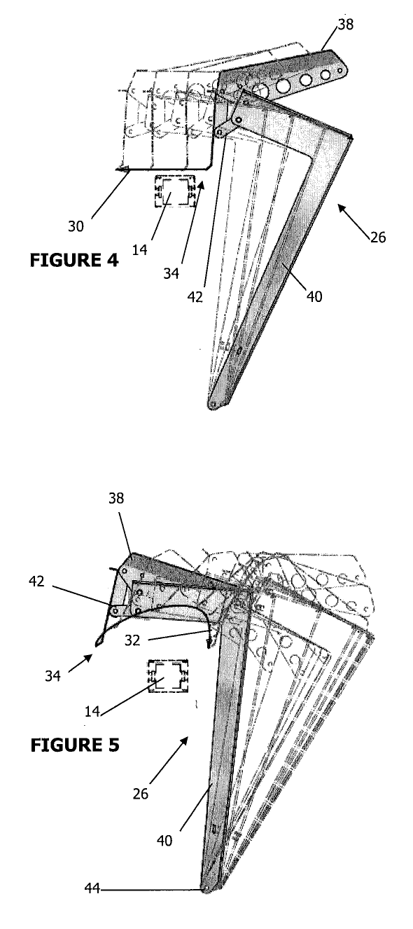

FIGS. 4 and 5 depict the linkage 26 and pushing member 16 of the apparatus 10. More particularly, FIG. 4 shows in said lines the linkage 26 and pushing member 16 in the rest position, as well as subsequent configurations of the linkage 26 and the pushing member 16 during the first stroke (in broken lines). Arrow 30 illustrates the substantially horizontal movement of the pushing member 16 during the first stroke which facilitates successful transfer of the items 12 from the conveyor 14. Similarly, FIG. 5 shows the linkage 26 and pushing member 16 in solid lines in the extended position, as well as subsequent configurations of the linkage 26 and pushing member 16 during the second stroke (in broken lines). Arrow 32 illustrates the arcuate motion of a lower edge 34 of the pushing member 16 during the second stroke.

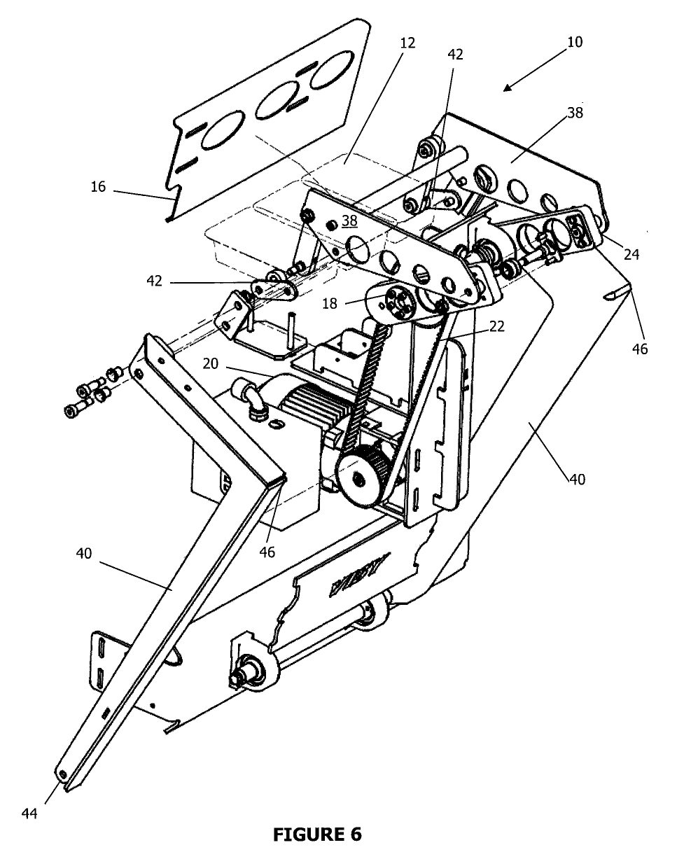

With reference to the partially exploded perspective view of the apparatus 10 shown in FIG. 6, the rotational member 18 includes the driving arm 36, and the linkage 26 includes a link 38, an elongated arm 40, and a tie member 42 which couple the pushing member 16 to the driving arm 36. More specifically, the link 38 is pivotally coupled at each end between the driving arm 36 and the pushing member 16, the elongated arm 40 is pivotally coupled at each end between the link 38 and a pivot 44 which is fixed in position relative to the support of the conveyor 14, and the tie member 42 is pivotally coupled at each end between the elongated arm 40 and the pushing member 16.

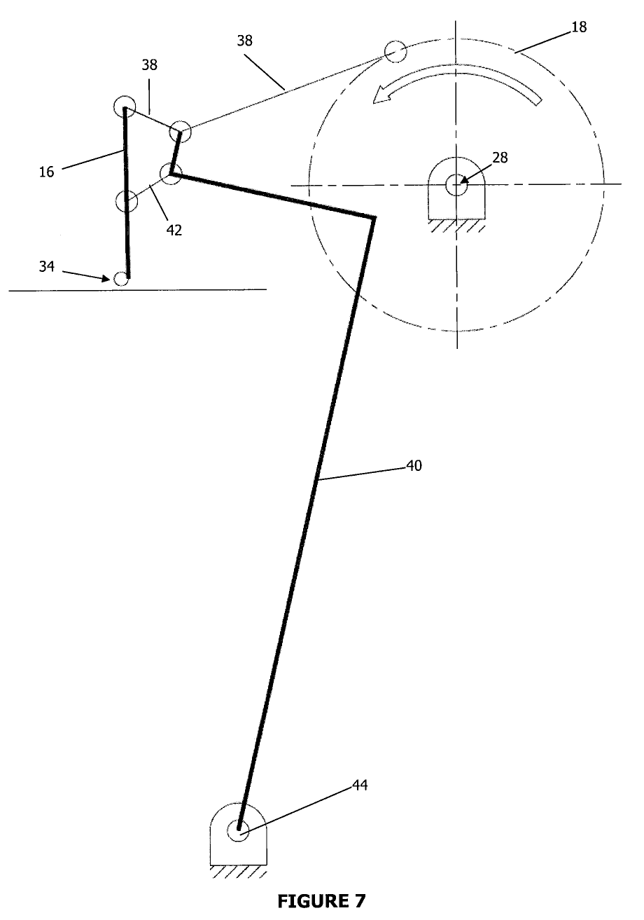

FIG. 7 provides a simple diagrammatic side view of the rotational member 18, driving arm 24, link 38, elongated arm 40, tie member 42, and pushing member 16, which facilitates an understanding of the motion of these components through the first and second strokes. The elongated arm 40, which incorporates a substantially right-angled bend at location 46 to facilitate movement of the pushing member 16 over the conveyor 14, oscillates about the pivot 44 in response to continuous rotation of the rotational member 18. As will be appreciated, acceleration of the pushing member 16 in an initial part of the first stroke, and deceleration of the pushing member 16 in a final part of the first stroke, facilitate successful transfer of the items 12 from the conveyor 14 by avoiding damage to the items 12 through abrupt movement, as well as by encouraging correct location of the items 12 when deposited from the conveyor 14 by avoiding overshoot. Advantageously, this promotes delivery of undamaged products, as well as smooth subsequent processing of the items 12 by avoiding incorrect location of the items 12 when transferred.

Advantageously, the arcuate motion of the pushing member 16 during the second stroke enables the pushing member to pass over the top of incoming items on the conveyor 14, thus speeding up processing of the items by allowing the items to arrive in place (ie. for pushing by the apparatus 10) during the previous cycle of motion of the apparatus 10. Although the arcuate motion depicted in the example shown in the drawings is generally parabolic, it will be appreciated by those skilled in the art that other arcuate motion of the pushing member 16 may be used in alternative examples.

The above apparatus 10 has been described by way of example only and modifications are possible within the scope of the invention. In one alternative example, the acceleration of the pushing member during the initial part of the first stroke and the deceleration of the pushing member 16 during the final part of the first stroke are retained, but the pushing member 16 has substantially horizontal motion during the second stroke (rather than the arcuate motion of the example described above). Even without the arcuate motion in the second stroke, this alternative example is advantageous due to the acceleration and deceleration of the pushing member 16 facilitating accurate delivery of undamaged items, by way of gentle movement of the items.

Examples of the invention may be used to push items from one surface to another surface, whether or not one or both of the surfaces is/are of a conveyor or conveyors. An apparatus in accordance with an example of the invention may also be used to push items from one position on a surface to another position on the same surface.

The reference in this specification to any prior publication (or information derived from it), or to any matter which is known, is not, and should not be taken as an acknowledgment or admission or any form of suggestion that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. An apparatus for pushing items relative to a surface, the apparatus including a pushing member for engaging the items, and drive means for moving the pushing member such that in response to operation of the drive means the pushing member moves from a rest position to an extended position in a first stroke substantially horizontally in a direction across the surface so as to push the items relative to the surface, and with further operation of the drive means the pushing member returns to the rest position in a second stroke with an arcuate motion which clears items on the surface.

2. An apparatus as claimed in claim 1, wherein the surface is a conveyor, and the first stroke is in a direction transverse to the conveyor.

3. An apparatus as claimed in claim 2, wherein the apparatus includes a linkage coupling the drive means to the pushing member, wherein the linkage is arranged to provide movement of the pushing member in said first and second strokes in response to operation of the drive means.

4. An apparatus as claimed in claim 3, wherein the drive means is a rotational member.

5. An apparatus as claimed in claim 4, wherein the linkage is arranged such that with constant rotational velocity of the rotational member the pushing member accelerates then decelerates along the first stroke, and with continuous rotation of the rotational member the pushing member repeatedly cycles through the first and second strokes.

6. An apparatus as claimed in claim 4, wherein the rotational member is driven by a motor and rotates about an axis which is fixed in relation to a support of the conveyor.

7. An apparatus as claimed in claim 6, wherein the rotational member includes a driving arm, and the linkage includes:
a link pivotally coupled between the driving arm and the pushing member;
an elongated arm pivotally coupled between the link and a pivot fixed in
position relative to the support of the conveyor, the elongated arm being arranged to oscillate about the pivot in response to continuous rotation of the rotational member; and
a tie member pivotally coupled between the elongated arm and the pushing member;
wherein dimensions of the link, the elongated arm and the tie member, and the locations of the pivots, are selected to provide said motion of the pushing member along the first and second strokes.

8. An apparatus as claimed in claim 1, wherein the arcuate motion is generally parabolic.

9. An apparatus as claimed in claim 2, wherein the arcuate motion enables the pushing member to clear incoming items on the conveyor when returning to the rest position through the second stroke.

10. An apparatus for pushing items relative to a surface, the apparatus including a pushing member for engaging the items, and drive means for moving the pushing member such that in response to operation of the drive means the pushing member moves from a rest position to an extended position in a first stroke substantially horizontally in a direction across the surface so as to push the items relative to the surface, the pushing member accelerating then decelerating along the first stroke, and wherein with further operation of the drive means the pushing member returns to the rest position in a second stroke.

11. An apparatus as claimed in claim 10, wherein the surface is a conveyor, and the first stroke is in a direction transverse to the conveyor.

12. An apparatus as claimed in claim 11, wherein the apparatus includes a linkage coupling the drive means to the pushing member, wherein the linkage is arranged to provide movement of the pushing member in said first and second strokes in response to operation of the drive means.

13. An apparatus as claimed in claim 12, wherein the drive means is a rotational member.

14. An apparatus as claimed in claim 13, wherein the linkage is arranged such that with constant rotational velocity of the rotational member the pushing member accelerates during a start portion of the first stroke and then decelerates during an end portion of the first stroke.

15. An apparatus as claimed in claim 13, wherein the linkage is arranged such that with continuous rotation of the rotational member the pushing member repeatedly cycles through the first and second strokes.

16. An apparatus as claimed in claim 15, wherein the linkage is arranged such that the rotational member is beyond a dead centre position when the pushing member is in the rest position.

17. An apparatus as claimed in claim 13, wherein the rotational member is driven by a motor and rotates about an axis which is fixed in relation to a support of the conveyor.

18. An apparatus as claimed in claim 17, wherein the rotational member includes a driving arm, and the linkage includes:
a link pivotally coupled between the driving arm and the pushing member;
an elongated arm pivotally coupled between the link and a pivot fixed in
position relative to the support of the conveyor, the elongated arm being arranged to oscillate about the pivot in response to continuous rotation of the rotational member; and
a tie member pivotally coupled between the elongated arm and the pushing member;
wherein dimensions of the link, the elongated arm and the tie member, and the locations of the pivots, are selected to provide the acceleration then deceleration of the pushing member along the first stroke.

19. An apparatus for pushing items relative to a conveyor substantially as hereinbefore described with reference to the accompanying drawings.
